(19) United States
(12) Patent Application Publication
(10) Pub. No.: US 2009/0193944 A1
(43) Pub. Date: Aug. 6, 2009

(54) Ratchet device

(76) Inventor: Chung Cheng Yang, Taichung Hsien (TW)

Correspondence Address: CHARLES E. BAXLEY, ESQUIRE, 90 JOHN STREET, SUITE 309, NEW YORK, NY, 10038, US

(21) Appl. No.: 12/012,718

(22) Filed: Feb. 5, 2008

(51) Int. Cl. B25B 23/00

(52) U.S. Cl. 81/465; 81/437; 81/180.1; 81/63.2

(57) ABSTRACT

A ratchet device includes a housing having a number of teeth formed in a chamber of the housing, a follower having a stem engaged into the housing, a pawl disposed in the follower and having a number of teeth for engaging with the teeth of the housing, and a control ferrule attached to the follower and anchored between the follower and the housing and coupled to the pawl for controlling the teeth of the pawl to selectively engage with the teeth of the housing in order to control the rotating direction of the housing by the follower. An actuating member is attached to the control ferrule, and a spring member is attached to the actuating member and engage with the pawl for coupling the control ferrule to the pawl.

### BACKGROUND OF THE INVENTION

1. Field of the Invention

The present invention relates to a ratchet wrench or ratchet tool or ratchet device, and more particularly to a ratchet device including a structure for being easily assembled and for being easily operated by the users.

2. Description of the Prior Art

Various kinds of typical ratchet wrenches or tools or devices have been developed and comprise a ratchet wheel and a pawl disposed in a head portion of a ratchet wrench, and an actuating knob coupled to the pawl for actuating or controlling the pawl to selectively engage with the ratchet wheel and to control the driven direction of the ratchet wheel by the head portion of the ratchet wrench.

For example, U.S. Pat. No. 5,533,427 to Chow discloses one of the typical ratchet wrenches comprising a pawl including a number of teeth for engaging with the teeth of the ratchet wheel and for controlling the direction of the ratchet wheel to be rotated or driven by the head portion and/or the handle portion of the ratchet wrench, and a spring-biased ball or a ball and a spring engaged into the head portion of the ratchet wrench, and an actuating knob coupled to the pawl for actuating or controlling the pawl to selectively engage with the ratchet wheel.

However, the pawl may not be effectively controlled or actuated with the actuating knob.

U.S. Pat. No. 5,568,751 to Lee discloses another typical reversible ratchet wrench comprising a torsion transmitting element engaged in a cylindrical head, a pawl and a round rod engaged into the torsion transmitting element and a rotating button coupled to the round rod for actuating or controlling the pawl to selectively engage with the teeth of the head portion of the ratchet wrench and to control the driven direction of the torsion transmitting element by the head portion of the ratchet wrench.

However, similarly, the pawl may not be effectively controlled or actuated with the rotating button.

U.S. Pat. No. 5,626,062 to Colvin discloses a further typical socket and ratchet wrench comprising a drive gear and a reversing pawl engaged into a head, and a reversing lever coupled to the pawl for actuating or controlling the pawl to selectively engage with the teeth of the drive gear.

However, similarly, the pawl may not be effectively controlled or actuated with the reversing lever.

U.S. Pat. No. 5,692,420 to Byers discloses a still further typical socket wrench comprising a ratchet mechanism including a housing engaged into a head and having an arm extended from the housing, and a lock member for selectively locking the arm of the housing.

However, similarly, the arm of the housing and the ratchet mechanism may not be effectively controlled or actuated by the users.

U.S. Pat. No. 5,916,339 to Dumont discloses a still further typical ratchet tool comprising a locking pawl and a cylindrical body engaged into a head, and a rotary member coupled to the locking pawl with an operating spring.

However, it will be difficult to assemble and couple the operating spring to the locking pawl.

U.S. Pat. No. 5,964,129 to Shiao discloses a still further typical ratchet wrench comprising a circular adapter engaged into a head, and a ratchet member is engaged into the head for engaging with the circular adapter, and an operating knob coupled to the ratchet member for rotating the ratchet member relative to the head of the ratchet wrench.

However, the operating knob is engaged in a tiny opening of the head and may not be easily operated by the user.

U.S. Pat. No. 6,164,166 to Whiteford discloses a still further typical ratchet wrench comprising a cylindrical head and a pawl engaged into a head, and an integral tab coupled to the pawl for actuating or controlling the pawl to selectively engage with the teeth of the cylindrical head.

However, the pawl include few teeth for engaging with the teeth of the cylindrical head such that the driving torque of the cylindrical head by the head of the ratchet wrench is greatly decreased.

U.S. Pat. No. 6,435,063 to Chen discloses a still further typical ratchet wrench comprising a hollow cylindrical notched member and a pawl or follower engaged into a head, and a thin trigger member coupled to the follower for actuating or controlling the follower to selectively engage with the teeth of the notched member.

However, the pawl may not be effectively controlled or actuated to engage with the teeth of the notched member.

U.S. Pat. No. 6,807,881 to Wu discloses a still further typical ratchet wrench comprising a number of rods engaged into a head, and a switching member having a number of fingers extended therefrom for engaging with the rods and for actuating or controlling the rods to selectively engage with the teeth of the inner actuating surfaces of the head.

However, the rods may not be effectively controlled or actuated to engage with the inner actuating surfaces of the head with the switching member.

The present invention has arisen to mitigate and/or obviate the afore-described disadvantages of the conventional ratchet wrenches or tools or devices.

### SUMMARY OF THE INVENTION

The primary objective of the present invention is to provide a ratchet device including a structure for being easily assembled and for being easily operated by the users.

In accordance with one aspect of the invention, there is provided a ratchet device comprising a housing including a chamber formed therein, and including a number of teeth formed in the chamber of the housing, a torsion transmitting element including a follower having a stem extended therefrom for engaging into the chamber of the housing, the follower including a notch formed therein, a pawl disposed in the notch of the follower and including a number of teeth formed therein for engaging with the teeth of the housing and for controlling a rotating direction of the housing by the follower, and a control ferrule rotatably attached onto the stem of the follower and rotatably anchored and retained between the follower and the housing, the control ferrule is coupled to the pawl for controlling the pawl and for forcing the teeth of the pawl to selectively engage with the teeth of the housing in order to control the rotating direction of the housing by the follower, the ratchet device includes a structure that may be easily assembled and that may be easily operated by the users.

An actuating member is further provided and attached to the control ferrule, and a spring member is further provided and attached to the actuating member and engage with the pawl for indirectly coupling the control ferrule to the pawl and for allowing the pawl to be controlled or operated or actuated by the control ferrule.

The pawl includes at least one orifice formed therein, and the spring member includes at least one leg engaged into the orifice of the pawl for moving the pawl and for forcing the teeth of the pawl to selectively engage with the teeth of the housing in order to control the rotating direction of the housing by the follower. The actuating member includes a compartment formed therein for receiving the spring member.

The actuating member includes a bulge extended therefrom for engaging with the leg of the spring member and for forcing the leg of the spring member to engage with the pawl. The actuating member includes a slot formed in the bulge for engaging with the spring member and for anchoring the spring member to the actuating member.

The actuating member includes two inclined or tilted surfaces formed therein for engaging with the stem of the follower and for limiting a rotational movement of the actuating member and the control ferrule relative to the housing and the follower, and for determining an engagement of the teeth of the pawl with the teeth of the housing and thus for controlling the rotating direction of the housing by the follower.

The control ferrule includes a space formed therein for receiving and for engaging with the actuating member and for anchoring the actuating member to the control ferrule. The control ferrule includes at least one catch extended therefrom for engaging with the actuating member and for stably anchoring the actuating member to the control ferrule.

The pawl includes two inclined or tilted surfaces formed therein for engaging with the stem of the follower and for limiting a rotational movement of the pawl relative to the housing and the follower. The follower includes an engaging hole formed therein for engaging with a driving member of a driving tool.

The housing includes a peripheral recess formed therein and communicating with the chamber of the housing, and the follower includes a spring-biased member for engaging with the peripheral recess of the housing and for rotatably securing and coupling the follower to the housing.

The follower includes a conduit formed therein, and the spring-biased member includes a spring member and two detents engaged into the conduit of the follower, and the spring member is disposed between the detents for biasing and forcing the detents to engage with the peripheral recess of the housing in order to rotatably secure and couple the follower to the housing and thus for preventing the follower from being disengaged or separated from the housing.

The follower includes a cavity formed therein, and a ball and a spring member engaged into the cavity of the follower, and the spring member biases the ball to engage with the control ferrule and to position the control ferrule to the follower. The control ferrule includes three depressions formed therein for selectively engaging with the ball and for positioning the control ferrule to the follower at selected positions, or for positioning the teeth of the pawl either in engagement with the teeth of the housing or in disengagement from the teeth of the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a ratchet device in accordance with the present invention;

FIG. 2 is a partial exploded view of the ratchet device;

FIG. 3 is a perspective view illustrating an actuating member of the ratchet device;

FIG. 4 is a cross sectional view of the ratchet device taken along lines 4-4 of FIG. 1;

FIGS. 5, 6, 7 are cross sectional views taken along lines 5-5, 6-6, 7-7 of FIG. 4 respectively; and

FIG. 8 is a cross sectional view similar to FIG. 5 illustrating the operation of the ratchet device.

### DETAILED DESCRIPTION OF THE PREFERRED EMBODIMENT

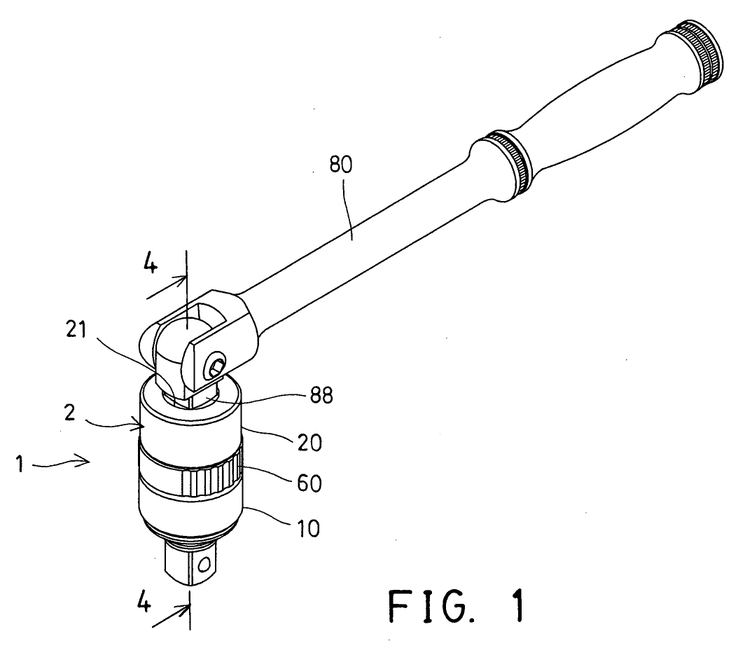

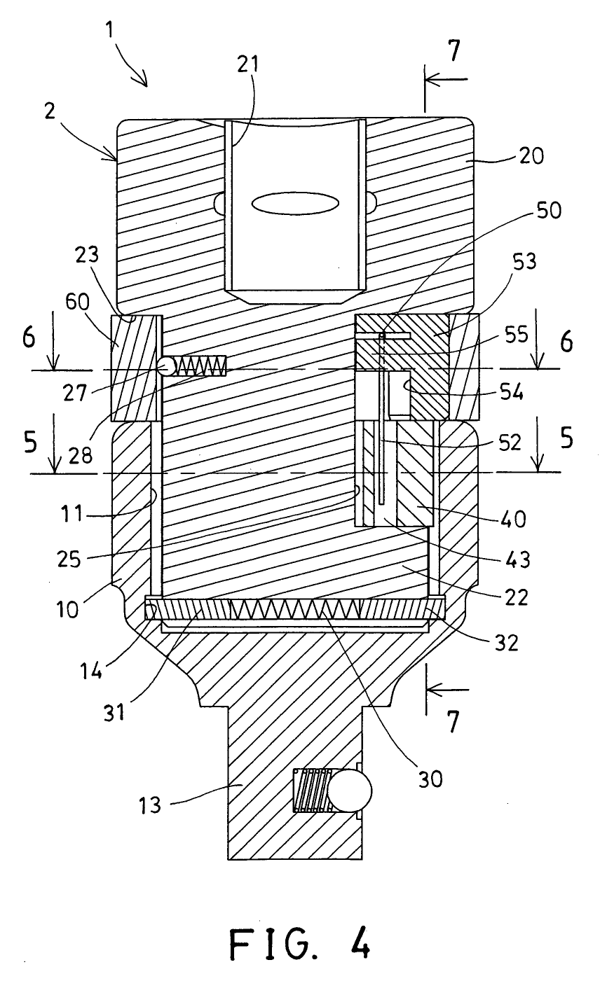

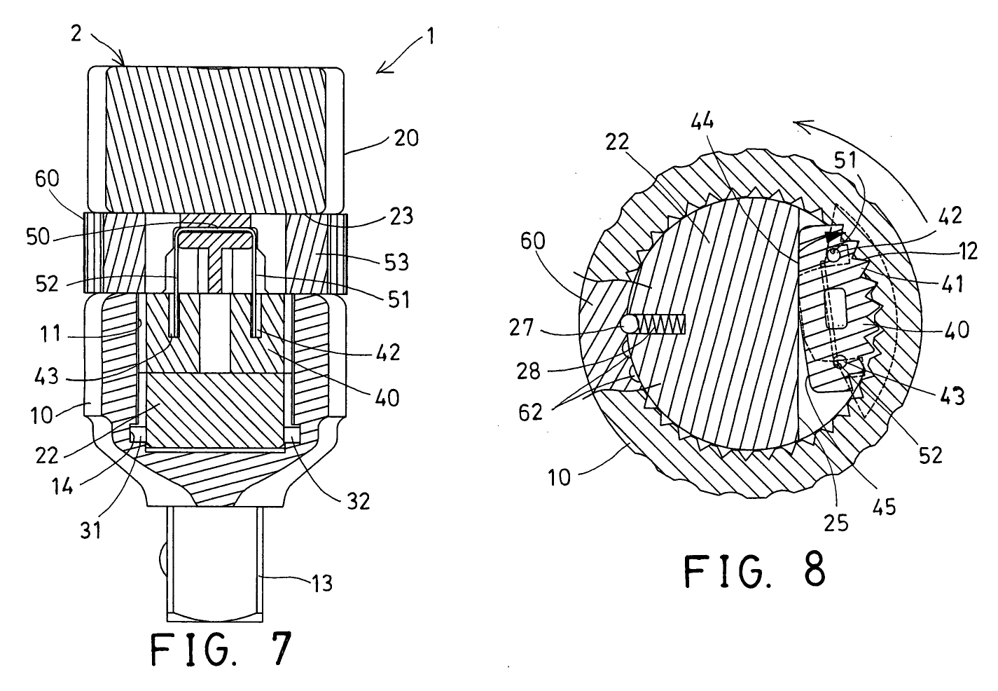

Referring to the drawings, and initially to FIGS. 1-4, a ratchet device 1 in accordance with the present invention comprises a housing 10, such as a cylindrical housing 10 including a chamber 11 formed therein, and including an internal gear or a number of teeth 12 formed in the chamber 11 of the housing 10, and including a shank 13 extended downwardly therefrom for engaging with the fasteners or tool couplers or tool members (not shown) and for allowing the fasteners or tool couplers or tool members to be rotated or driven by the housing 10, and including a peripheral recess 14 formed in the inner portion of the housing 10 (FIGS. 4, 7) and communicating with the chamber 11 of the housing 10.

A torsion transmitting element 2 includes a follower 20 having an engaging hole 21 formed therein for receiving or for engaging with the driving member 88 of a driving tool 80 (FIG. 1) and for allowing the follower 20 to be rotated or driven by the driving member 88 of the driving tool 80. The follower 20 includes a stem 22 extended downwardly therefrom for engaging into the chamber 11 of the housing 10 (FIGS. 4, 5, 7), and the stem 22 includes an outer diameter smaller than that of the follower 20 for forming a peripheral shoulder 23 in the follower 20 or between the follower 20 and the stem 22. The follower 20 further includes a conduit 24 laterally formed in or through the stem 22 and preferably located or situated at the lower portion of the stem 22 and distal to the engaging hole 21 of the follower 20.

A spring-biased member includes a spring member 30 and two detents 31, 32 engaged into the conduit 24 of the stem 22 or of the follower 20, and the spring member 30 is disposed between the detents 31, 32 for biasing and forcing the detents 31, 32 to engage with the peripheral recess 14 of the housing 10 (FIGS. 4, 7) and for rotatably securing or coupling the stem 22 of the follower 20 to the housing 10 and for preventing the follower 20 from being disengaged from the housing 10. The stem 22 further includes a notch 25 formed therein or formed in one side portion of the stem 22, and includes a cavity 26 formed in the stem 22 for receiving a ball 27 and another spring member 28, in which the spring member 28 may bias the ball 27 to partially extend out of the stem 22 (FIGS. 4, 6, 8).

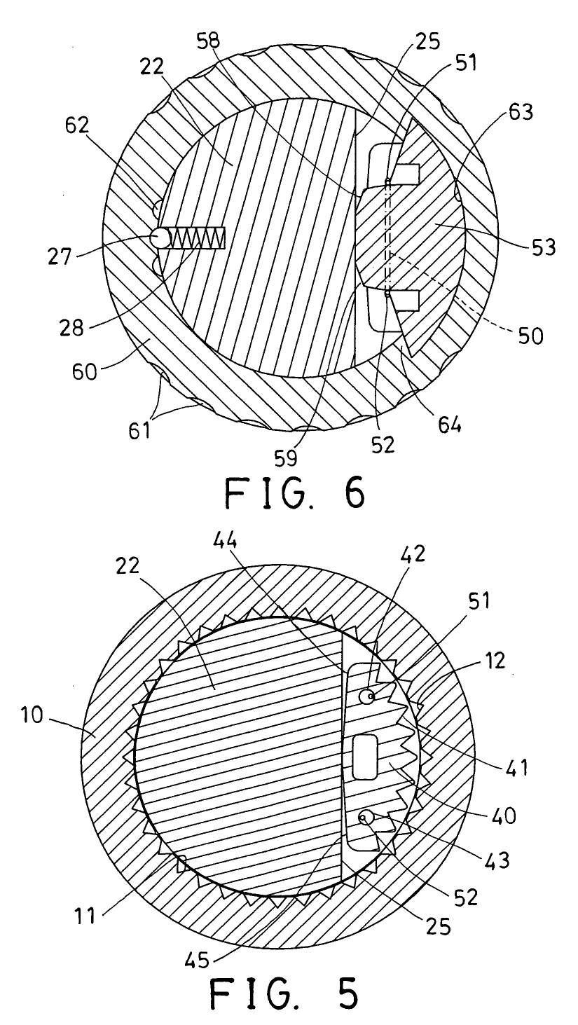

A reversing pawl 40 is disposed in the notch 25 of the stem 22 or of the follower 20, and includes a number of teeth 41 formed therein for engaging with the teeth 12 of the housing 10 and for controlling the rotating or driving direction of the housing 10 by the follower 20. In operation, as shown in FIG. 5, when the pawl 40 is disposed or arranged in the middle portion of the notch 25 of the stem 22 or of the follower 20, the teeth 41 of the pawl 40 may be disengaged from the teeth 12 of the housing 10 such that the housing 10 and the follower 20 may be freely rotated relative to each other.

As shown in FIG. 8, when the pawl 40 is disposed or moved to one side or one end of the notch 25 of the stem 22 or of the follower 20, the housing 10 may be actuated or driven to rotate in one direction, such as the counterclockwise direction; and on the contrary, the housing 10 may be actuated or driven to rotate in the other direction, such as the clockwise direction when the pawl 40 is disposed or moved to the other side or the other end of the notch 25 of the stem 22 or of the follower 20 (not shown). The pawl 40 includes one or more (such as two) orifices 42, 43 formed therein such as formed in the upper portion of the pawl 40 for engaging with a further spring member 50.

For example, the spring member 50 includes two limbs or legs 51, 52 engaged into the orifices 42, 43 of the pawl 40 respectively for moving the pawl 40 to either of the sides or ends of the notch 25 of the stem 22 or of the follower 20 and for forcing the teeth 41 of the pawl 40 to selectively engage with the teeth 12 of the housing 10 in order to control the rotating or driving direction of the housing 10 by the follower 20. The pawl 40 includes two inclined or tilted surfaces 44, 45 formed therein for selectively engaging with the stem 22 of the follower 20 (FIG. 8) and for limiting or determining the rotational movement of the pawl 40 relative to the housing 10 and the follower 20, and/or for determining the selective engagement of the teeth 41 of the pawl 40 with the teeth 12 of the housing 10.

A control ferrule 60 is rotatably attached or engaged onto the stem 22 and engaged with the peripheral shoulder 23 of the follower 20 and also engaged with the housing 10 for allowing the control ferrule 60 to be rotatably anchored and retained or secured between the follower 20 and the housing 10, and includes a serrated or course outer peripheral surface 61 for allowing the control ferrule 60 to be easily rotated relative to the housing 10 and the follower 20 by the users, and includes one or more (such as three) depressions 62 formed therein for selectively engaging with the spring-biased ball 27 and for positioning or retaining the control ferrule 60 to the stem 22 of the follower 20 at selected or predetermined positions or locations, and includes a space 63 formed therein and having one or more (such as two) catches 64 extended into the sides or ends of the space 63 of the control ferrule 60.

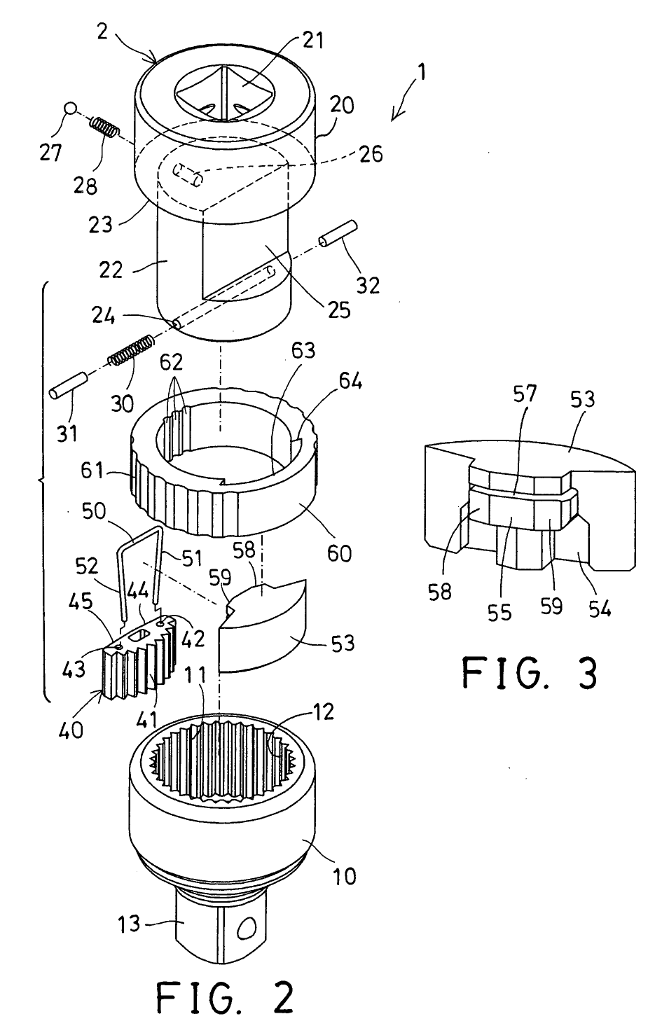

As shown in FIGS. 2-4 and 6, an actuating member 53 is engaged into the space 63 of the control ferrule 60 and attached or secured to the control ferrule 60 with such as a force-fitted engagement, and the catches 64 of the control ferrule 60 may be engaged with the actuating member 53 for solidly anchoring or securing the actuating member 53 to the control ferrule 60. In addition, the actuating member 53 may also be stably anchored and retained between the follower 20 and the housing 10. The actuating member 53 includes a compartment 54 formed therein for receiving the spring member 50, and includes a bulge 55 extended outwardly therefrom for engaging with the spring member 50, or for engaging between the legs 51, 52 of the spring member 50 and thus for forcing the legs 51, 52 of the spring member 50 to resiliently engage with the pawl 40.

The actuating member 53 further includes a slot 57 formed in the bulge 55 (FIG. 3) for receiving or for engaging with the spring member 50 (FIG. 4) and thus for further stably anchoring and retaining the spring member 50 to the actuating member 53 and to the pawl 40, and includes two inclined or tilted surfaces 58, 59 formed therein for selectively engaging with the stem 22 of the follower 20 (FIG. 6) and for limiting or determining the rotational movement of the actuating member 53 and thus the control ferrule 60 relative to the housing 10 and the follower 20, and/or for determining the engagement of the teeth 41 of the pawl 40 with the teeth 12 of the housing 10.

The control ferrule 60 may thus be coupled to the pawl 40 directly or indirectly with the actuating member 53 and the spring member 50 for controlling the pawl 40 and for forcing the teeth 41 of the pawl 40 to selectively engage with the teeth 12 of the housing 10 in order to control the rotating or driving direction of the housing 10 by the follower 20.

Accordingly, the ratchet device in accordance with the present invention includes a structure for being easily assembled and for being easily operated by the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A ratchet device comprising:
a housing including a chamber formed therein, and including a plurality of teeth formed in said chamber of said housing,
a torsion transmitting element including a follower having a stem extended therefrom for engaging into said chamber of said housing, said follower including a notch formed therein and including a cavity formed therein,
a ball and a spring member engaged into said cavity of said follower,
a pawl disposed in said notch of said follower and including a plurality of teeth formed therein for engaging with said teeth of said housing and for controlling a rotating direction of said housing by said follower, and
a control ferrule rotatably attached onto said stem of said follower and rotatably anchored and retained between said follower and said housing, said control ferrule being coupled to said pawl for controlling said pawl and for forcing said teeth of said pawl to selectively engage with said teeth of said housing in order to control the rotating direction of said housing by said follower, and said spring member biasing said ball to engage with said control ferrule and to position said control ferrule to said follower.

2. The ratchet device as claimed in claim 1, wherein an actuating member is attached to said control ferrule, and a spring member is attached to said actuating member and engage with said pawl for coupling said control ferrule to said pawl.

3. The ratchet device as claimed in claim 2, wherein said pawl includes at least one orifice formed therein, and said spring member includes at least one leg engaged into said at least one orifice of said pawl for moving said pawl and for forcing said teeth of said pawl to selectively engage with said teeth of said housing in order to control the rotating direction of said housing by said follower.

4. The ratchet device as claimed in claim 2, wherein said actuating member includes a compartment formed therein for receiving said spring member.

5. The ratchet device as claimed in claim 2, wherein said actuating member includes a bulge extended therefrom for engaging with said at least one leg of said spring member and for forcing said at least one leg of said spring member to engage with said pawl.

6. The ratchet device as claimed in claim 5, wherein said actuating member includes a slot formed in said bulge for engaging with said spring member and for anchoring said spring member to said actuating member.

7. The ratchet device as claimed in claim 2, wherein said actuating member includes two surfaces formed therein for engaging with said stem of said follower and for limiting a rotational movement of said actuating member and said control ferrule relative to said housing and said follower, and for determining an engagement of said teeth of said pawl with said teeth of said housing.

8. The ratchet device as claimed in claim 2, wherein said control ferrule includes a space formed therein for receiving and for engaging with said actuating member and for anchoring said actuating member to said control ferrule.

9. The ratchet device as claimed in claim 8, wherein said control ferrule includes at least one catch extended therefrom for engaging with said actuating member and for stably anchoring said actuating member to said control ferrule.

10. The ratchet device as claimed in claim 2, wherein said pawl includes two surfaces formed therein for engaging with said stem of said follower and for limiting a rotational movement of said pawl relative to said housing and said follower.

11. A ratchet device comprising:
a housing including a chamber formed therein, and including a plurality of teeth formed in said chamber of said housing, said housing including a peripheral recess formed therein and communicating with said chamber of said housing,
a torsion transmitting element including a follower having a stem extended therefrom for engaging into said chamber of said housing, said follower including a notch formed therein, and said follower including a spring-biased member for engaging with said peripheral recess of said housing and for rotatably securing and coupling said follower to said housing,
a pawl disposed in said notch of said follower and including a plurality of teeth formed therein for engaging with said teeth of said housing and for controlling a rotating direction of said housing by said follower, and
a control ferrule rotatably attached onto said stem of said follower and rotatably anchored and retained between said follower and said housing, said control ferrule being coupled to said pawl for controlling said pawl and for forcing said teeth of said pawl to selectively engage with said teeth of said housing in order to control the rotating direction of said housing by said follower.

12. The ratchet device as claimed in claim 11, wherein said follower includes a conduit formed therein, and said spring-biased member includes a spring member and two detents engaged into said conduit of said follower, and said spring member is disposed between said detents for biasing and forcing said detents to engage with said peripheral recess of said housing.

13. (canceled)

14. The ratchet device as claimed in claim 1, wherein said control ferrule includes three depressions formed therein for selectively engaging with said ball and for positioning said control ferrule to said follower at selected positions.

15. The ratchet device as claimed in claim 1, wherein said follower includes an engaging hole formed therein for engaging with a driving member of a driving tool.
